(19) United States
(12) Patent Application Publication
(10) Pub. No.: US 2018/0370449 A1
(43) Pub. Date: Dec. 27, 2018

(54) DEVICE FOR MOUNTING SUITCASE TO CAR AND SUITCASE CONTAINING SAME

(71) Applicant: Avriel BAR JOSEPH, Zikron Yaacov (IL)

(72) Inventor: Avriel BAR JOSEPH, Zikron Yaacov (IL)

(21) Appl. No.: 16/064,669

(22) PCT Filed: Dec. 21, 2016
(86) PCT No.: PCT/IL2016/051365

§ 371 Date: Jun. 21, 2018

Related U.S. Application Data
(60) Provisional application No. 62/270,601, filed on Dec. 22, 2015.

(51) Int. Cl. B60R 9/058; B60R 9/048; B60R 9/045

(52) U.S. Cl. CPC B60R 9/058; B60R 2011/004; B60R 9/045; B60R 9/048

(57) ABSTRACT

A luggage carrier including a mounting element configured to attach the luggage carrier to an external surface of a vehicle.

### TECHNICAL FIELD

The present disclosure generally relates to the field of mechanisms for mounting luggage carriers to a vehicle. Specifically, the application relates to luggage carriers including mounting mechanisms configured to securely mount the luggage carrier to a vehicle.

### BACKGROUND

Automotive transport is an integral part of modern conveyance. With such conveyance, luggage must also frequently be transported in addition to passengers. External luggage racks are typically considered a felicitous solution to the compounded difficulties of transporting large amounts of luggage, unwieldy parcels, and the like.

### SUMMARY

Aspects of the disclosure, in some embodiments thereof, relate to mounting devices configured to be attached to a luggage carrier and to enable attachment of the luggage carrier to an external surface of a vehicle, including vehicles devoid of external luggage racks.

A common problem in automotive transport is the insufficient space in the luggage storage compartment of the vehicle. This inter alia results from the tradeoff between the demand for small, cost efficient cars and storage space.

Typical solutions are “car oriented” and include various types of luggage racks attached to the external surface of the car.

However, multiple problems are encountered using such car oriented solutions. First of all, being car oriented, it requires that the car transporting the luggage actually includes a luggage rack. The second problem is that luggage racks, when mounted on vehicles, cause drag, which slows down the car and/or increases its fuel expenses.

Advantageously, the mounting device, disclosed herein is “luggage-oriented”, i.e. it is configured to be attached to or is an integral part of a luggage carrier (e.g. a suitcase) and to be transported therewith. The device may, according to some embodiments, be configured to be attachable to any standard luggage carrier, transforming the luggage carrier into a mobile luggage rack. As a result, the luggage may be mounted on an external surface of any vehicle, including vehicles devoid of luggage racks. As a further advantage, the attachment of the mounting device to the luggage carrier may be a simple, e.g. one-click attachment. The mounting device may thus be stored e.g. in the luggage compartment of the vehicle, thereby reducing unnecessary drag and fuel expenses, when external storage is not required. This may be of particular importance in commercial transport vehicles, such as taxis or rental cars.

According to other embodiments, the mounting device may an integral part of a luggage carrier, custom built to be mountable to an external surface of a vehicle.

According to some embodiments, there is provided a luggage carrier comprising a mounting element configured to attach the luggage carrier to an external surface of a vehicle. According to some embodiments, the vehicle is devoid of a luggage rack.

According to some embodiments, the luggage carrier further comprises a release mechanism configured to prevent release of the mounting element from the external surface of the vehicle unless the release mechanism is actively triggered.

According to some embodiments, the luggage carrier further comprises at least one shock absorber configured to prevent direct contact between the luggage carrier and the external surface of the vehicle, when mounted thereon.

According to some embodiments, the luggage carrier further comprises at least one secure band configured to secure the attachment of the luggage carrier to the mounting element and/or to the external surface of the vehicle.

According to some embodiments, the luggage carrier further comprises a GPS configured to enable tracking thereof.

According to some embodiments, the luggage carrier has an aerodynamic shape.

According to some embodiments, the mounting element comprises an extendable rod, a magnet, an electromagnet, a vacuum member, a biological glue, a nonskid adhesive material, a hook and loop fastener or any combination thereof.

According to some embodiments, the mounting element comprises an extendable rod comprising at least two handles, the handles comprising a mounting mechanism enabling mounting of the luggage carrier to an external surface of a vehicle. According to some embodiments, the extendable rod is configured to assume at least a first essentially non-extended position and a second at least partially extended position. According to some embodiments, at least two handles are configured to assume a position essentially perpendicular to the at least one extendable rod when mounted to the external surface of the vehicle, such that a gap is formed between the external surface of the vehicle and the at least one extendible rod. According to some embodiments, the at least one rod is a double-armed extendable rod comprising two handles, each handle at opposite ends of the extendible rod. According to some embodiments, the single extendable rod is a telescopic rod configured to be extended at both ends thereof. According to some embodiments, the at least one extendable rod is positioned on the luggage carrier such that a first of the at least two handles is at a bottom side of the luggage carrier and the second of the at least two handles is at the top side of the luggage carrier. According to some embodiments, the second handle is further configured to allow carriage of the luggage carrier.

According to some embodiments, the luggage carrier further comprises a switch mechanism configured for switching between the first essentially non-extended position and the second at least partially extended position.

According to some embodiments, there is provided a vehicle comprising the luggage carrier, as essentially described herein. According to some embodiments, the vehicle is an autonomic car.

According to some embodiments, there is provided a mounting device configured for attachment to a luggage carrier, the mounting device comprising at least one extendable rod configured for attachment to the luggage carrier, the at least one extendable rod comprising at least two handles, the handles comprising a mounting mechanism enabling mounting of the extendable rod to an external surface of a vehicle; wherein the extendable rod is configured to assume at least a first essentially non-extended position and a second at least partially extended position; and wherein the extendable rod is configured for attachment to the luggage carrier when in its first essentially non-extended position prior to the mounting of the extendable rod to the external surface of the vehicle.

According to some embodiments, at least one of the at least two handles is configured to assume a first position in which the handle is coextensive with the extendable rod and a second position in which the handle assumes a position essentially perpendicular to the extendable rod.

According to some embodiments, the at least two handles are configured to assume a position essentially perpendicular to the at least one extendable rod when mounted to the external surface of the vehicle, such that a gap is formed between the external surface of the vehicle and the at least one extendible rod.

According to some embodiments, the at least one rod is a double-armed extendable rod comprising two handles, each handle at opposite ends of the double armed extendible rod.

According to some embodiments, the double-armed extendable rod is a telescopic rod configured to be extended at both ends thereof.

According to some embodiments, the at least one extendable rod is configured for attachment to the luggage carrier along a longitudinal axis thereof.

According to some embodiments, the at least one extendable rod is configured for attachment to the luggage carrier such that a first of the at least two handles is at a bottom side of the luggage carrier and the second of the at least two handles is at the top side of the luggage carrier. According to some embodiments, the second handle is further configured to allow carriage of the luggage carrier, when the extendable rod is attached thereto.

According to some embodiments, the mounting mechanism is selected from a mechanical, a magnetic, an electromagnetic, an adhesive, a hook and loop fastener or any combination thereof.

According to some embodiments, the mounting mechanism comprises a release mechanism configured to prevent release of said extendable rod from the external surface of the vehicle unless the release mechanism is actively triggered.

According to some embodiments, the device further comprises a switch mechanism configured for switching between the first essentially non-extended position and the second at least partially extended position.

According to some embodiments, the device further comprises a detachment mechanism allowing detachment of the luggage carrier from the extendable rod only when the detachment mechanism is activated.

According to some embodiments, the at least one extendable rod comprises at least one shock absorber configured to prevent direct contact between the at least one extendable rod and the external surface of the vehicle, when mounted thereon.

According to some embodiments, the device further comprises a GPS configured to enable tracking thereof.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

### BRIEF DESCRIPTION OF THE DRAWINGS

Some embodiments of the disclosure are described herein with reference to the accompanying figures. The description, together with the figures, makes apparent to a person having ordinary skill in the art how some embodiments of the disclosure may be practiced. The figures are for the purpose of illustrative discussion and no attempt is made to show structural details of an embodiment in more detail than is necessary for a fundamental understanding of the teachings of the disclosure. For the sake of clarity, some objects depicted in the figures are not to scale.

FIG. 1A illustratively depicts a front view of a luggage carrier including a double armed extendable mounting member in a partially expanded configuration, according to some embodiments;

FIG. 1B illustratively depicts a perspective side view of the luggage carrier of FIG. 1A with its mounting member in an extended configuration, according to some embodiments;

FIG. 1C illustratively depicts a perspective side view of the luggage carrier of FIG. 1A and FIG. 1B mounted to surface, according to some embodiments;

FIG. 2A illustratively depicts a rear view of a luggage carrier including vacuum members, according to some embodiments;

FIG. 2B illustratively depicts a side view of the luggage carrier of FIG. 2A, according to some embodiments;

FIG. 3A illustratively depicts a rear view of a luggage carrier including two perpendicular positioned double-armed extendable mounting members, according to some embodiments;

FIG. 3B illustratively depicts a side view of the luggage carrier of FIG. 3A, according to some embodiments;

FIG. 4A illustratively depicts a rear view of a luggage carrier including a rotatable double-armed extendable mounting member, according to some embodiments;

FIG. 4B illustratively depicts a side view of the luggage carrier of FIG. 4A, according to some embodiments;

FIG. 5A illustratively depicts a front view of a luggage carrier mounted on a roof of a car along its longitudinal axis, according to some embodiments;

FIG. 5B illustratively depicts a rear view of a luggage carrier mounted on a roof of a car along its longitudinal axis, according to some embodiments;

FIG. 5C illustratively depicts a side view of a luggage carrier mounted on a roof of a car along its longitudinal axis, according to some embodiments;

FIG. 5D illustratively depicts a front view of a luggage carrier mounted on a roof of a car along its longitudinal axis and a luggage carrier mounted on a trunk of a car along its longitudinal axis, according to some embodiments;

FIG. 6A illustratively depicts a front view of a luggage carrier mounted on a roof of a car along its transversal axis, according to some embodiments;

FIG. 6B illustratively depicts a rear view of a luggage carrier mounted on a roof of a car along its transversal axis, according to some embodiments;

FIG. 6C illustratively depicts a side view of a luggage carrier mounted on a roof of a car along its transversal axis, according to some embodiments;

FIG. 6D illustratively depicts a front view of a luggage carrier mounted on a roof of a car along its transversal axis and a luggage carrier mounted on a trunk of the car along its longitudinal axis, according to some embodiments;

FIG. 7, illustratively depicts a perspective view of a luggage carrier mounted on a roof, according to some embodiments;

FIG. 8 illustratively depicts a front view of a car having a plurality of luggage carriers mounted on a roof thereof, according to some embodiments;

FIG. 9 illustratively depicts a side view of a car having a plurality of luggage carriers mounted on a roof thereof, according to some embodiments;

FIG. 10 illustratively depicts a rear view of a luggage carrier including adhesive members, according to some embodiments;

FIG. 11 illustratively depicts a side view of a luggage carrier including extendible rods at a front and a rear side thereof.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

According to some embodiments, there is provided mounting device configured for attachment to a luggage carrier, the mounting device including at least one extendable mounting member configured for attachment to the luggage carrier. According to some embodiments, the at least one mounting member may include a mounting mechanism configured to mount the extendable rod to an external surface of a vehicle.

According to some embodiments, the extendable mounting member may be configured to be attached to the luggage carrier when in its first essentially non-extended position. According to some embodiments, the extendable mounting member may be configured to be attached to the luggage carrier prior to the mounting of the extendable mounting member to the external surface of the vehicle.

According to some embodiments, the vehicle may be any vehicle such as a car, a van, a lorry, a camper, a scooter, a motorcycle or any other suitable vehicle. According to some embodiments, the car is an autonomic car. Autonomic cars often have small sized luggage compartments and the device is therefore of particular advantage for such autonomic cars.

As used herein, the term “luggage carrier” may refer to any type of carrier configured to include luggage or goods therein or to carry subject (i.e. babies) and to enable transport thereof. Non-limiting examples of suitable luggage carriers include suitcases, backpacks, duffel bags, travel bags, picnic boxes, tool boxes, prams, strollers or any other suitable luggage or personnel container. Each possibility is a separate embodiment. According to some embodiments, the luggage carrier may have an aerodynamic shape, thereby causing minimal drag to the vehicle, upon which it is mounted. According to some embodiments, the luggage carrier or parts thereof (e.g. the rear side thereof) may be made of a relatively stiff, impregnable material facilitating safe use in all weather conditions and speeds of drive.

As used herein, the terms “mounting device”, “mounting element” and “mounting member” may be used interchangeably and may refer to any element or structure configured to mount a luggage carrier, to which it is attached, to an external surface of a vehicle, such as, but not limited to, a car roof, trunk door, a rear end of a van or any other suitable external surface of any vehicle. According to some embodiments, the mounting mechanism is configured to mount a first luggage carrier to an external surface of a vehicle and to stack a subsequent luggage carrier to the first luggage carrier and so forth.

As used herein, the term “mounting mechanism” may refer to any mechanism configured to allow the mounting of the mounting device to an external surface of a vehicle. Non-limiting examples of suitable mounting mechanisms include mechanical mounting mechanisms, magnetic mounting mechanisms, electromagnetic mounting mechanisms, vacuum mechanisms, adhesives, biological glues (such as, but not limited to, Geckskin™), Nonskid adhesive material, hook and loop fasteners (such as, but not limited to, Velcro®) or any suitable material or combination of materials.

As used herein, the term “extendable rod” may refer to any elongated element configured for attachment to a luggage carrier and to assume at least a first essentially non-extended configuration and a second at least partially extended configuration. According to some embodiments, the extendable rod may be a double armed rod. As used herein, the term “double armed” when referring to the extendable rod may refer to two parallel positioned sticks attached to one another at least one point along the lengths thereof. According to some embodiments, the two sticks of the double armed rod may be interconnected at at least one end thereof through a handle. According to some embodiments, the two sticks of the double armed rod may be interconnected at both ends thereof through a handle. According to some embodiments, the extendable rod may have a shape of a flat plate.

According to some embodiments, the extendable rod (whether double armed or in the shape of a flat plate) may be configured to be extended into one or more pre-fixed configurations. For example, the rod may be configured to be extended into one or more predetermined configurations/positions fitting the breadth/length of most standard vehicles. Additionally or alternatively, the at least partially extended configuration may be user-determined so as to be adjusted to the breadth/length of any vehicle.

According to some embodiments, the mounting device may further include a switch mechanism configured to switch between the non-extendable configuration and the at least partially extended configuration. According to some embodiments, the switching mechanism may be configured to prevent a change in the degree of extension of the at least one extendable rod (whether fixed or user determined), unless the switching mechanism is actively triggered.

According to some embodiments, the at least one rod may include at least two handles. As used herein, the term “handle” may refer to any element positioned on an end of the rod and optionally to interconnect the sticks of the double armed. According to some embodiments, the handles may be configured to have or assume a position/configuration which generates a gap between the external surface of the vehicle and the at least one extendible rod, thereby minimizing harm to the external surface, when mounted thereon. According to some embodiments, at least one of the handles may include an activating mechanism configured to cause/trigger the extension of the extendable rod. According to some embodiments, at least one of the at least two handles may further be used as a traditional carriage handle, i.e. to lift and carry a luggage carrier to which it is attached.

According to some embodiments, the extendable rod may be a telescopic rod. According to some embodiments, the telescopic rod may be extendable from both ends thereof in which case the rod has a handle at both ends thereof. When utilizing a rod extendable at both its end, the mounting mechanism may include a single (optionally double-armed) rod configured for attachment to the luggage carrier. According to some embodiments, the telescopic rod may be extendable from one end thereof only, in which case the handle is positioned at the extendable end of the rod. When utilizing a rod extendable at one end thereof only, the mounting mechanism may include two extendable rods, each rod configured to attachment to the luggage carrier.

According to some embodiments, the mounting mechanism may include more than two extendable rods such as 3, 4, 5, 6 or more extendable rods. Each possibility is a separate embodiment.

According to some embodiments, the at least one rod may include the mounting mechanism, such as but not limited to a vacuum member, an electromagnet or other suitable mounting mechanism. According to some embodiments, the mounting mechanism may be positioned on the at least two handles of the rod.

According to some embodiments, at least one of the at least two handles may be configured to assume a first position in which the handle is coextensive with the extendable rod and a second position in which the handle assumes a bent position, e.g. bent approximately 90° relative to the extendable rod.

According to some embodiments, the at least one extendable rod may be configured for attachment to the luggage carrier along its longitudinal axis, as further described hereinbelow. Additionally or alternatively, the at least one extendable rod may be configured for attachment to the luggage carrier along its transversal axis, as further described hereinbelow. According to some embodiments, the at least one extendable rod may be configured for attachment to the luggage carrier, such that a first of the at least two handles is at a bottom side of the luggage carrier (e.g. adjacent the wheels of a suitcase) and the second of the at least two handles be at the top side of the luggage carrier. According to some embodiments, the handle at the top side of the luggage carrier may serve as a carriage handle in addition to its function in mounting the luggage carrier to the vehicle.

According to some embodiments, the extendable rod may be configured to be attached to the external surface of a vehicle along its longitudinal axis, e.g. along the length of a car's roof. Additionally or alternatively, the extendable rod may be configured to be attached to the external surface of a vehicle perpendicularly to its longitudinal axis, e.g. along the breadth of a car's roof.

According to some embodiments, the mounting device may include a release mechanism configured to release the mounting device from the external surface of the vehicle. According to some embodiments, the release mechanism may be configured to prevent the extendable rod from being released from the external surface of the vehicle as long as the release mechanism has not been actively triggered.

According to some embodiments, the mounting device may further include a detachment mechanism configured to enable detachment of the extendable rod from the luggage carrier. According to some embodiments, the detachment mechanism may be configured to prevent detachment of the extendable rod from the luggage carrier unless the detachment mechanism is actively triggered.

According to some embodiments, the at mounting device may include at least one shock absorber configured to prevent direct contact between the mounting device and the external surface of the vehicle when mounted thereon. According to some embodiments, the at least one shock absorber may be positioned on the at least one double armed extendable rod. According to some embodiments, the at least one shock absorber may be mounted on or be an integral part of at least one side of the luggage carrier (e.g. a back of a suitcase). According to some embodiments, the at least one shock absorber may include more than one shock absorber, such as 2, 3, 4 or more shock absorbers. Each possibility is a separate embodiment.

According to some embodiments, the mounting device may include one or more secure bands configured to secure the mounting device to the luggage carrier and/or to the external surface of the vehicle. According to some embodiments, the one or more secure bands may be a pull string. As used herein the term “pull string” refers to a string which when not in use is folded/rolled into a compact form. In its compact form, the pull string may be contained in a dedicated compartment. According to some embodiments, the pull string includes a handle configured to enable the pull string to be unfolded and/or to be pulled out of the dedicated compartment, thereby enable its use. According to some embodiments, the pull string will automatically retract into its dedicated compartment and into its compact form when a pull force is not exerted thereon. Alternatively, the pull string may retract into its dedicated compartment and into its compact form as a result of triggering a mechanism, e.g. pressing a button.

According to some embodiments, the mounting device may include a tracking device such as but not limited to a GPS configured to enable tracking thereof.

According to some embodiments, there is provided a luggage carrier including a mounting element configured to attach the luggage carrier to an external surface of a vehicle, including vehicles devoid of luggage racks.

According to some embodiments, the mounting element may be or include at least one magnet configured to secure the luggage carrier to an external surface by magnetic force, the magnetic force of the magnet being of a strength preventing unwanted (accidental) release of the luggage carrier from the vehicle. According to some embodiments, the at least one magnet may include 1, 2, 3, 4 or more magnets. Each possibility is a separate embodiment. According to some embodiments, the at least one magnet may be poisoned on any side of the luggage carrier, e.g. on the front, the back, or a side of the luggage carrier. Each possibility is a separate embodiment. According to some embodiments, the luggage carrier may include a single magnet. According to some embodiments, the magnet may be positioned essentially at the center of any of the sides of the luggage carrier (e.g. at the center of a rear side of a suitcase). According to some embodiments, the luggage carrier may include at least two magnets. According to some embodiments, the at least two magnets may be positioned at spaced apart positions on a same side of the luggage carrier (e.g. at a top and bottom of a rear side of a suitcase). According to some embodiments, the luggage carrier may include at least four magnets. According to some embodiments, the at least four magnets may be positioned at spaced apart positioned on a same side of the luggage carrier (e.g. at each corner of a rear side of a suitcase).

According to some embodiments, the mounting element may be or include at least one electromagnet configured to secure the luggage carrier to an external surface of a vehicle by magnetic force. According to some embodiments, the mounting element may include a battery (e.g. a rechargeable battery) or other power source, which when activated generates the electromagnetic field. According to some embodiments, the magnetic field of the electromagnet may be generated directly or indirectly by ignition of the vehicle to which the luggage carrier is mounted. According to some embodiments, the magnetic force of the electromagnet is of a strength preventing unwanted (accidental) release of the luggage carrier from the vehicle. According to some embodiments, deactivation of the power source enables release of the luggage carrier from the surface to which it is mounted. According to some embodiments, the at least one electromagnet may include 1, 2, 3, 4 or more electromagnets. Each possibility is a separate embodiment. According to some embodiments, the at least one electromagnet may be poisoned on any side of the luggage carrier, e.g. on the front, the back, or a side of the luggage carrier. Each possibility is a separate embodiment. According to some embodiments, the luggage carrier may include a single electromagnet. According to some embodiments, the electromagnet may be positioned at the center of on any of the sides of the luggage carrier (e.g. at the center of a rear side of a suitcase). According to some embodiments, the luggage carrier may include at least two electromagnets. According to some embodiments, the at least two electromagnets may be located at spaced apart positions on a same side of the luggage carrier (e.g. at a top and bottom of a rear side of a suitcase). According to some embodiments, the luggage carrier may include at least four electromagnets. According to some embodiments, the at least four electromagnets may be located at spaced apart positions on a same side of the luggage carrier (e.g. at each corner of a rear side of a suitcase).

According to some embodiments, the mounting element may be or include at least one vacuum member configured to secure the luggage carrier to the external surface of a vehicle by vacuum force. It is understood that the vacuum member be sized and shaped to ensure that unwanted release of the luggage carrier from the external surface is prevented. According to some embodiments, the vacuum member includes a release mechanism configured to release the vacuum and thus the luggage carrier from the surface when desired. According to some embodiments, the at least one vacuum member may include 1, 2, 3, 4 or more vacuum members. Each possibility is a separate embodiment. According to some embodiments, the at least one vacuum member may be poisoned on any side of the luggage carrier, e.g. on the front the back, or side of the luggage carrier. Each possibility is a separate embodiment. According to some embodiments, the luggage carrier may include a single vacuum member. According to some embodiments, the vacuum member may be position at a center of any of the sides of the luggage carrier (e.g. at a central point of a rear side of a suitcase). According to some embodiments, the luggage carrier may include at least two vacuum members. According to some embodiments, the at least two vacuum members may be located at spaced apart positions on a same side of a luggage carrier (e.g. at a top and a bottom of a rear side of a suitcase). According to some embodiments, the luggage carrier may include at least four vacuum members. According to some embodiments, the at least four vacuum members may be located at spaced apart positions on a same side of the luggage carrier (e.g. at each corner of a rear side of a suitcase).

According to some embodiments, the mounting element may include at least one of the extendable (optionally double-armed rods, disclosed herein. According to some embodiments, the extendable rod may include a mounting mechanism, such as any of the mounting mechanism disclosed herein. According to some embodiments, the at least one rod may be poisoned on any side of the luggage carrier, e.g. on the front, the back, or side of the luggage carrier. Each possibility is a separate embodiment. According to some embodiments, the at least one extendable rod may be positioned on the luggage carrier such that a first of the at least two handles is at a bottom side of the luggage carrier (in proximity to its wheels) and the second of the at least two handles at the top side of the luggage carrier. According to some embodiments, the second handle may further be configured to allow carriage of the luggage carrier. According to some embodiments, the luggage carrier may include more than one extendable rod.

According to some embodiments, the mounting element may include a single rotatable extendable rod configured to assume a first position along the longitudinal axis of the luggage carrier and a second position along the transversal axis of the luggage carrier. According to some embodiments, the luggage carrier may include a knob or other element configured to switch/rotate the extendable rod from its first to its second position.

According to some embodiments, the luggage carrier may include more than one mounting elements, such as 2, 3, 4 or more mounting elements. Each possibility is a separate embodiment. According to some embodiments, the mounting elements may be same (e.g. two vacuum members, or two double armed extendable rods, as essentially described above) and/or different e.g. an electromagnet and two vacuum members.

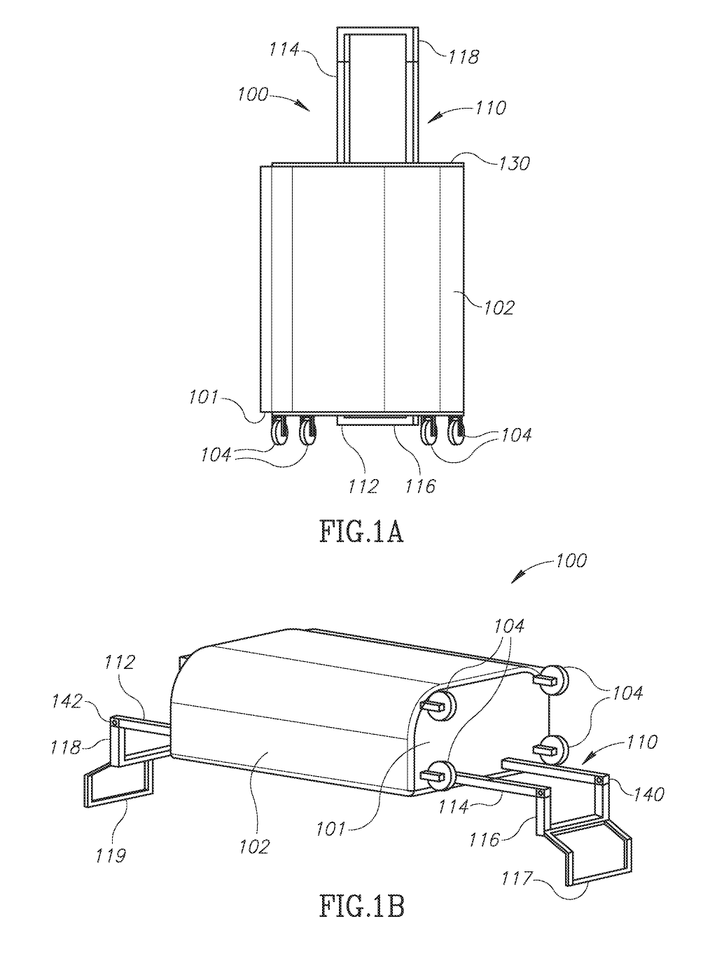

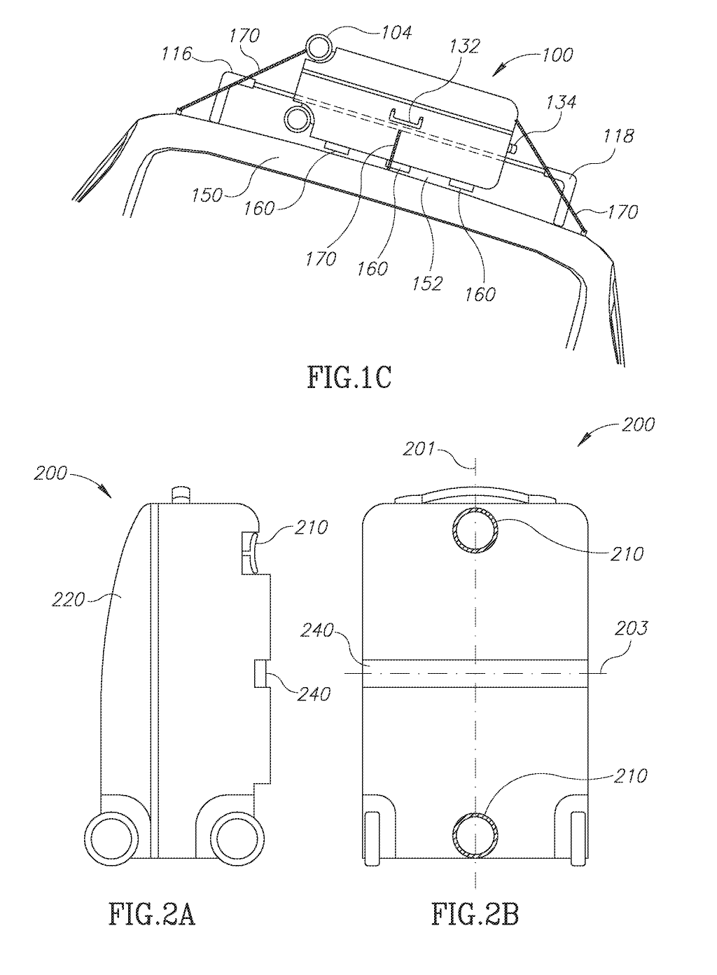

Reference is now made to the FIG. 1A-FIG. 1C, which illustratively depict a luggage carrier 100, here a suitcase including a double armed extendable rod 110. The body 102 of luggage carrier 100 is made from a stiff, lightweight material enabling safe use in all weather conditions and is aerodynamic in shape so as to cause minimal drag when mounted on a vehicle. As common today, luggage carrier 100 includes 4 wheels 104 at its bottom end 101 thereof, enabling convenient maneuvering, when dragged around. Extendable rod 110 is here mounted on a rear side of luggage carrier 100, in such manner that a first end 112 of extendable rod 110 slightly protrudes from bottom end 101 of luggage carrier 100. However, it is understood that other configurations, including but not limited to configurations in which first end 112 of extendable rod 110 protrudes further out from bottom end 101 of luggage carrier 100, aligns bottom end 101 of luggage carrier 100 or is shorter than to reach bottom end 101 of luggage carrier 100 (e.g. be positioned within a dedicated indent at the rear side of luggage carrier 100) may also be envisaged and are thus within the scope of this disclosure. It is further understood that extendable rod 110 may be attached to luggage carrier on an internal side of luggage carrier's 100 wall, on an external side of luggage carrier's 100 wall, or within the wall of luggage carrier 100. Each possibility is a separate embodiment. Extendable rod 110 includes a first handle 116 (best seen in FIG. 1B) at first end 112 thereof and a second handle 118 at second end 114 thereof. Extendable rod 110 may be extended from both ends separately. That is, extendable rod 110 may be extended at its second end 114 only, as shown in FIG. 1A, thereby assuming a position in which second handle 118 can serve as a regular handle for dragging of luggage carrier 100 or at both ends, as shown in FIG. 1C, enabling mounting of the rod to a surface. According to some embodiments, handles 116 and 118 may replace regular handles typically found on suitcases. Alternatively, handles 116 and 118 may be additional to regular handles, such as handles 132 and 134, as shown in FIG. 1C. This option is particularly suitable when extendable rod 110 is a stand-alone element removably attached to luggage carrier 100. It is understood that for storage, second end 114 may be collapsed into a non-extended position, e.g. aligned with a top end 130 of luggage carrier 100 (option not shown).

First handle 116 and second handle 118 are connected to extendable rod 110 through hinges 140 and 142 respectively, enabling first handle 116 and second handle 118 to assume a position in which first handle 116 and second handle 118 are bent essentially 90° relative to extendable rod 110, as shown in FIG. 1B. According to some embodiments, first and second handles 116 and 118 may include handle extensions 117 and 119 respectively, configured to fold out from a position in which they align handles 116 and 118, as shown in FIG. 1A to a spaced apart position, as shown in FIG. 1B. The spaced apart position of extensions 117 and 119 provide an enlarged gap 152 between luggage carrier 100 and the external surface 150 of the vehicle (not shown) to which it is attached, thereby minimizing the chance of luggage carrier 100 bumping against external surface 150. According to some embodiments, luggage carrier 100 may further include shock absorbing cushions, here illustratively depicted as three shock absorbing cushions 160 in FIG. 1C. Optionally, luggage carrier 100 may also include secure bands, illustratively depicted as three secure bands 170 in FIG. 1C. Secure bands 170 may be pull strings configured to be contained in a dedicated compartment (not shown) of luggage carrier 100, when not in use and to be pulled out from the compartment, when a securing of the attachment of luggage carrier 100 to external surface 150 of the vehicle is desired, as shown in FIG. 1C.

According to some embodiments, handles 116 and 118 and/or handle extensions 117 and 119 may include a mounting mechanism, such as a magnet, an electromagnet, a vacuum member or any suitable mounting mechanism, as essentially described herein (not shown), configured to securely mount luggage carrier 100 directly on external surface 150 of a vehicle, including vehicles devoid of luggage racks.

Reference is now made to FIG. 2A and FIG. 2B, which illustratively depict rear and side views of a luggage carrier 200 including vacuum members 210, according to some embodiments. The body 220 of luggage carrier 200 is made from a stiff, lightweight material enabling safe use in all weather conditions and is aerodynamic in shape, so as to cause minimal drag when mounted on a vehicle. Luggage carrier 200 is here shown to include two vacuum members, however it is understood that different number of vacuum members is also contemplated and thus within the scope of this disclosure, Similarly, vacuum members are here shown as being spaced apart along longitudinal axis 201 of luggage carrier 200, however it is understood that other configurations, such as but not limited to along a transverse axis 203 is also feasible and thus within the scope of this disclosure. Luggage carrier 200 further includes a vacuum supply member 240 configured to generate a vacuum between luggage carrier 200 and an external surface of a vehicle (not shown), on which it is placed, thereby securely mounting luggage carrier 200 directly onto the surface, including onto external surfaces of vehicles devoid of luggage racks. According to some embodiments, vacuum supply member 240 may be a channel to which a suction pump can be connected. According to some embodiments, vacuum supply member 240 may be a low-pressure compartment including a one-way valve (not shown) governing the fluid flow connection between vacuum members 220 and vacuum supply member 240. Opening of the valve creates flow of air from the space between vacuum members 220 of luggage carrier 200 and the external surface, on which it is placed, to vacuum supply member 240, consequently causing attachment of luggage carrier 200 to the external surface.

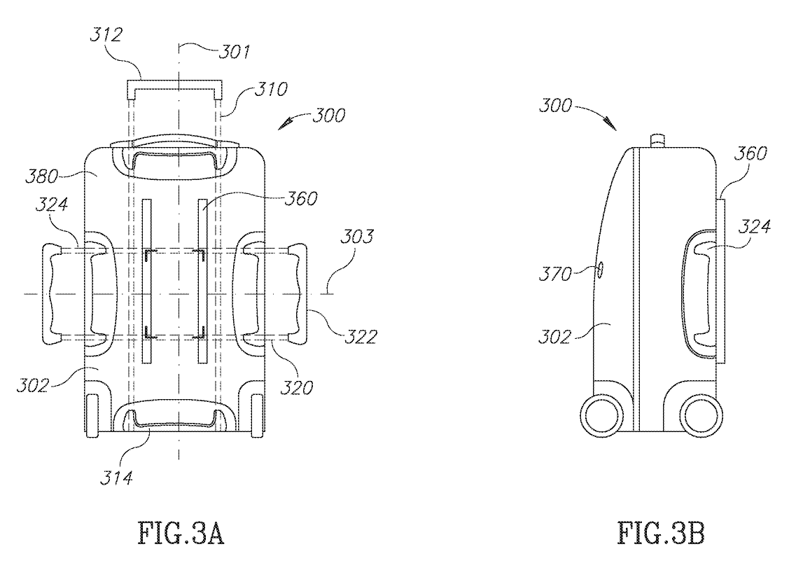

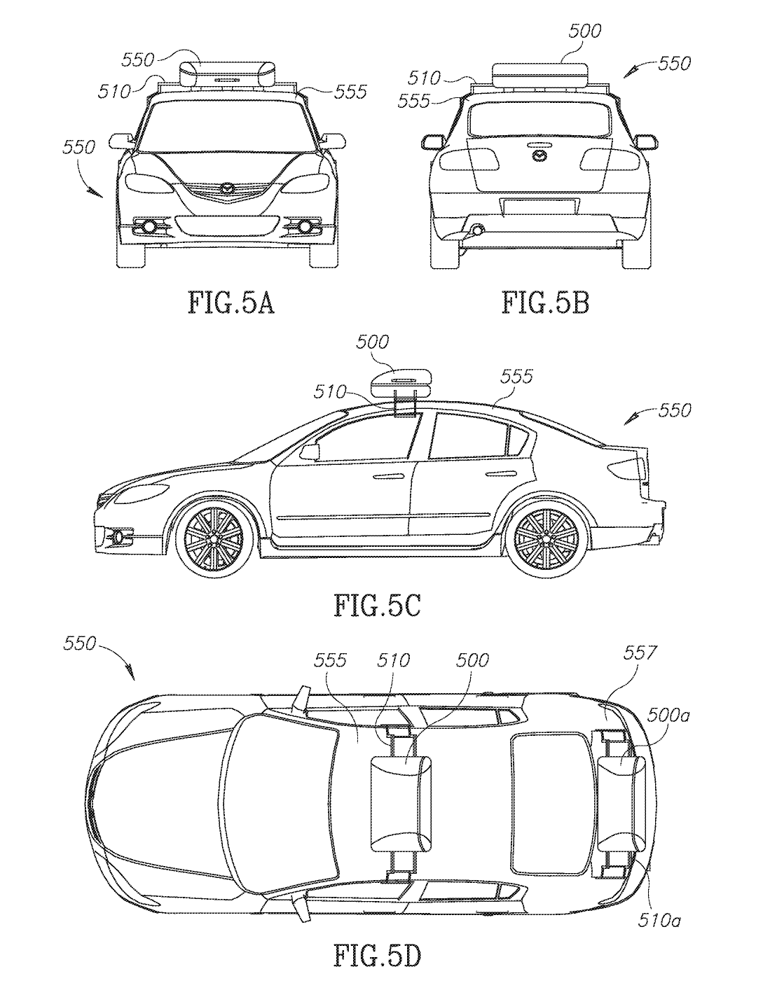

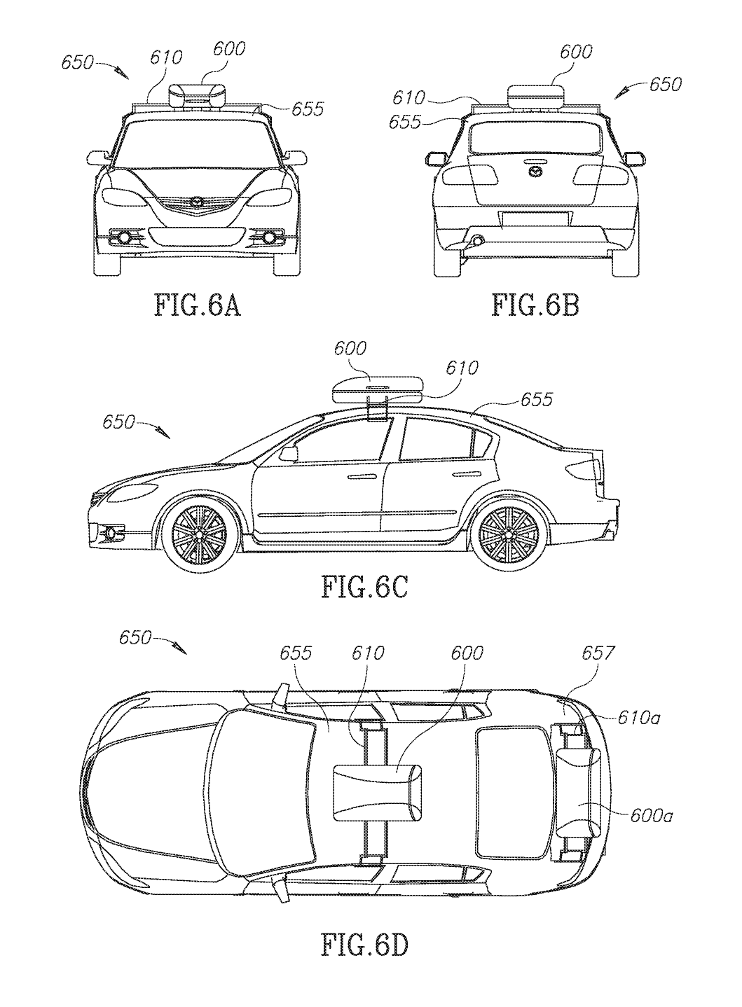

Reference is now made to FIG. 3A and FIG. 3B, which illustratively depict rear and side views of a luggage carrier 300 including a longitudinal positioned double armed extendable rod 310 and a transversely positioned double armed extendable rod 320, according to some embodiments. It is understood that longitudinal extendable rod 310 and transverse extendable rod 320 may be attached to luggage carrier 300 on an internal side of a rear wall 380 of luggage carrier 300, on an external side of rear wall 380, or within rear wall 380 of luggage carrier 300. Each possibility is a separate embodiment. Longitudinal positioned extendable rod 310 includes handles 312 and 314 which include a mounting mechanism (such as any of the mounting mechanisms described herein) configured to mount luggage carrier 300 onto an external surface of a vehicle (not shown) along its longitudinal axis 301, as essentially shown in FIG. 1C and FIG. 5A-FIG. 5D herein. Transversely positioned extendable rod 320 includes handles 322 and 324 which include a mounting mechanism configured to mount luggage carrier 300 to an external surface of a vehicle (not shown) along its transversal axis 303, as essentially shown in FIG. 6A-FIG. 6D herein. Luggage carrier 300 may further optionally include one or more secure band compartments, such as secure band compartment 370 configured to contain a secure band, which can be pulled out from secure band compartment 370, when additional securing of luggage carrier 300 to the surface upon which it is mounted, is desired. Luggage carrier 300 may further include shock absorbing cushions, illustratively depicted as two longitudinal % 360 configured to absorb impact between luggage carrier 300 and the external surface.

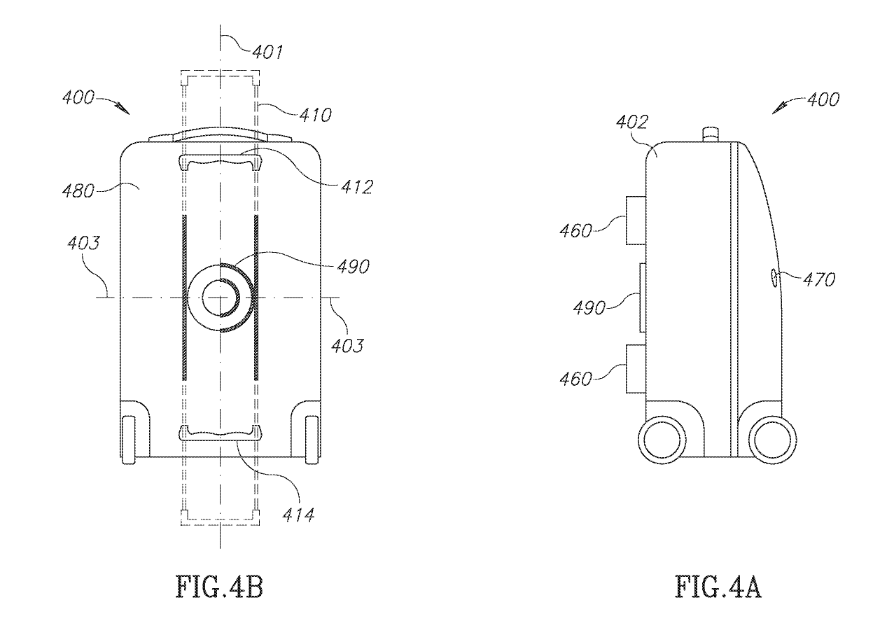

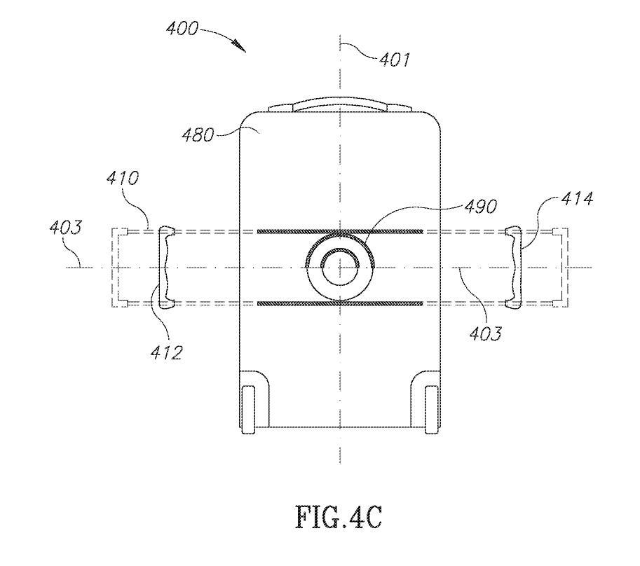

Reference is now made to FIG. 4A to FIG. 4C, which illustratively depict rear and side views of a luggage carrier 400 including a rotatable double-armed extendable rod 410, according to some embodiments. It is understood that extendable member 410 may be attached to luggage carrier 400 on an internal side of a rear wall 480 of luggage carrier 400, on an external side of rear wall 480, or within rear wall 480 of luggage carrier 400. Each possibility is a separate embodiment. The body 402 of luggage carrier 400 is made from a stiff, lightweight material enabling safe use in all weather conditions and is aerodynamic in shape, so as to cause minimal drag when mounted on a vehicle. Extendable rod 410 includes handles 412 and 414 which include a mounting mechanism (such as any of the mounting mechanisms described herein) configured to mount luggage carrier 400 on an external surface of a vehicle (not shown). Advantageable, luggage carrier 400 includes a knob 490, turning of which causes extendable member 410 to switch/rotate from a first longitudinal position shown in FIG. 4B to a second transverse position shown in FIG. 4C, and vice versa, thereby enabling attachment of luggage carrier 400 to an external surface of a vehicle, along either its longitudinal axis 401 or its transversal axis 403, as further illustrated herein below. It is understood that knob 490 is illustrative only and that other mechanism suitable for switching the position of extendable member 410 are also applicable and thus within the scope of the present disclosure. It is further understood that the degree of extension of extendable rod 410 required for mounting to the external surface of the vehicle may vary according to the longitudinal/transverse position of extendable member 410. For example, when extendable member 410 is in its first longitudinal position, the degree of extension required for mounting extendable member 410 on the external surface may be larger than that required, when extendable member 410 is in its second transverse position. The degree of extension may be predetermined (i.e. two fixed extension options) or user adjustable, as essentially described herein. Luggage carrier 400 may further optionally include one or more secure band compartments, such as secure band compartment 470 configured to contain a secure band, which can be pulled out from secure band compartment 470, when additional securing of luggage carrier 400 to the surface upon which it is mounted, is desired. Luggage carrier 400 may further include shock absorbing cushions, illustratively depicted as two longitudinal shock absorbing cushions 460 configured to absorb impact between luggage carrier 400 and the external surface.

Reference is now made to FIG. 5A to FIG. 5D which show front, rear, side and top views of a luggage carrier 500 mounted on a roof 555 of a car 550 along its longitudinal axis, according to some embodiments. In FIG. 5D, car 550 is further depicted to include an additional luggage carrier 500a mounted on a trunk 557 of car 550. Luggage carrier 500 and luggage carrier 500a include longitudinal positioned extendable rods 510 and 510a respectively which may be essentially similar to extendible rod 110 of FIG. 1A-FIG. 1C. Longitudinal positioned extendable rods 510 and 510a enable mounting of luggage carriers 500 and 500a along their longitudinal axis, directly on roof 555 and trunk 557 of car 550, without the need of a preinstalled luggage racks. It is understood that any other mounting element instead or in addition to extendable rod 510 may be used, and that such addition/substitution is contemplated by the disclosure. Advantageously, luggage carriers 500 and 500a may be made from a stiff, lightweight material enabling safe use in all weather conditions and may be aerodynamic in shape, so as to cause minimal drag to car 550 during drive.

Reference is now made to FIG. 6A to FIG. 6D which show front, rear, side on top views of a luggage carrier 600 mounted a roof 655 of a car 650 along its transversal axis, according to some embodiments. In FIG. 6D, car 650 is further depicted to include an additional luggage carrier 600a mounted on a trunk 657 of car 650 along its longitudinal axis. Luggage carrier 600 includes a transversally positioned extendable member 610, enabling mounting of luggage carrier 600 along its longitudinal axis, directly on roof 655 of car 650, without the need of a preinstalled luggage rack. Luggage carrier 600b includes a longitudinally positioned extendable member 610a, enabling mounting of luggage carrier 600a along its longitudinal axis, directly on trunk 657 of car 650, without the need of a preinstalled luggage rack. It is understood that any other mounting element instead or in addition to extendable member 610 may be used, and that such addition/substitution is contemplated by the disclosure. Luggage carriers 600 and 600a are made from a stiff, lightweight material enabling safe use in all weather conditions and are aerodynamic in shape, so as to cause minimal drag to car 650 during drive.

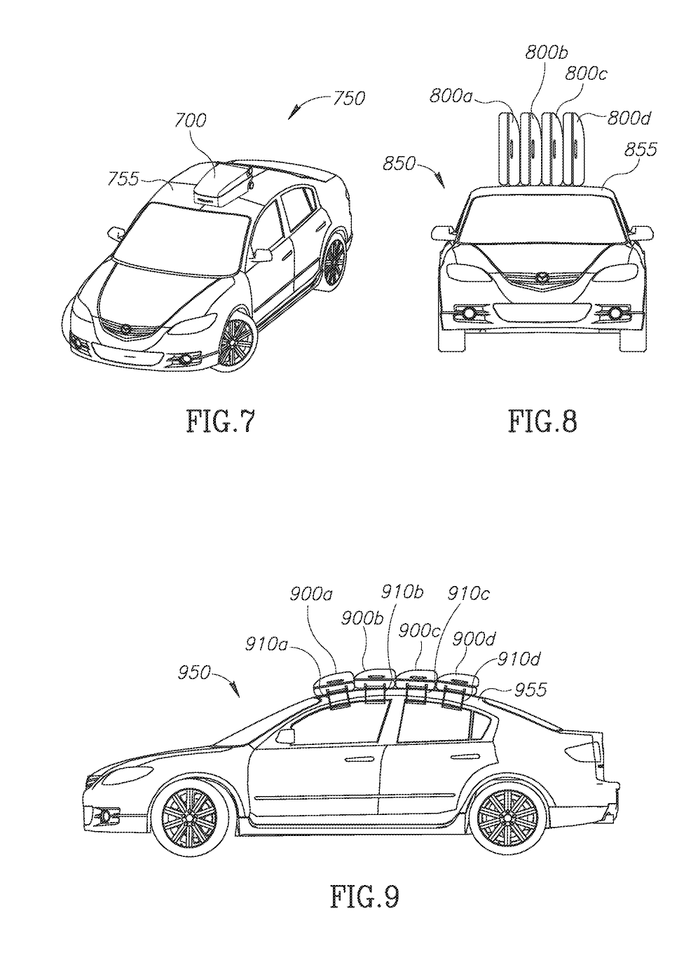

Reference is now made to FIG. 7, which depicts a perspective view of a luggage carrier 700 mounted on a roof 755 of a car 750. Luggage carrier 700 includes a mounting member (e.g. a vacuum member or an electromagnet—not shown) on a rear side thereof, enabling mounting of luggage carrier 700 directly on roof 755 of car 750, without the need of a preinstalled luggage rack. Advantageously, the mounting member enables attachment of luggage carrier 700 along any axis thereof. According to some embodiments, the mounting element may be movable so that its positioning (rear side, bottom side etc.) provide the best possible trade-off between the desire to reduce drag to car 750, the desired number of luggage carriers which require mounting and the area of external surface available.

Reference is now made to FIG. 8, which depicts a front view of four luggage carriers 800a-800d mounted on a roof 855 of a car 850. Luggage carriers 800a-800d include mounting members (not shown) on a bottom side thereof, enabling mounting of luggage carriers 800a-800d in an upright position directly on roof 855 of car 850, without the need of a preinstalled luggage rack. It is understood that the mounting element may be any of the mounting elements disclosed herein. It is further understood the mounting members may be positioned on any side of luggage carriers 800a-800d. According to some embodiments, the mounting element may be movable so that its positioning (rear side, bottom side etc.) provide the best possible trade-off between the desire to reduce drag to car 850, the desired number of luggage carriers which require mounting and the area of external surface available.

Reference is now made to FIG. 9, which depicts a side view of four luggage carriers 900a-900d mounted on a roof 955 of a car 950. Luggage carriers 900a-900d include mounting members 910a-910d, respectively, on a longitudinal axis thereof, enabling mounting of luggage carriers 900a-900d directly on roof 955 of car 950, without the need of a preinstalled luggage rack. Mounting members 910a-910d are here shown to be extendable rods, as essentially described herein, however it is understood that other mounting elements, such as any of the mounting elements disclosed herein are also applicable and thus within the scope of the disclosure. According to some embodiments, mounting elements 910a-910d may be movable so that their positioning on luggage carriers 900a-900d (rear side, bottom side etc.) provide the best possible trade-off between the desire to reduce drag to car 950, the desired number of luggage carriers which require mounting, and the area of external surface available.

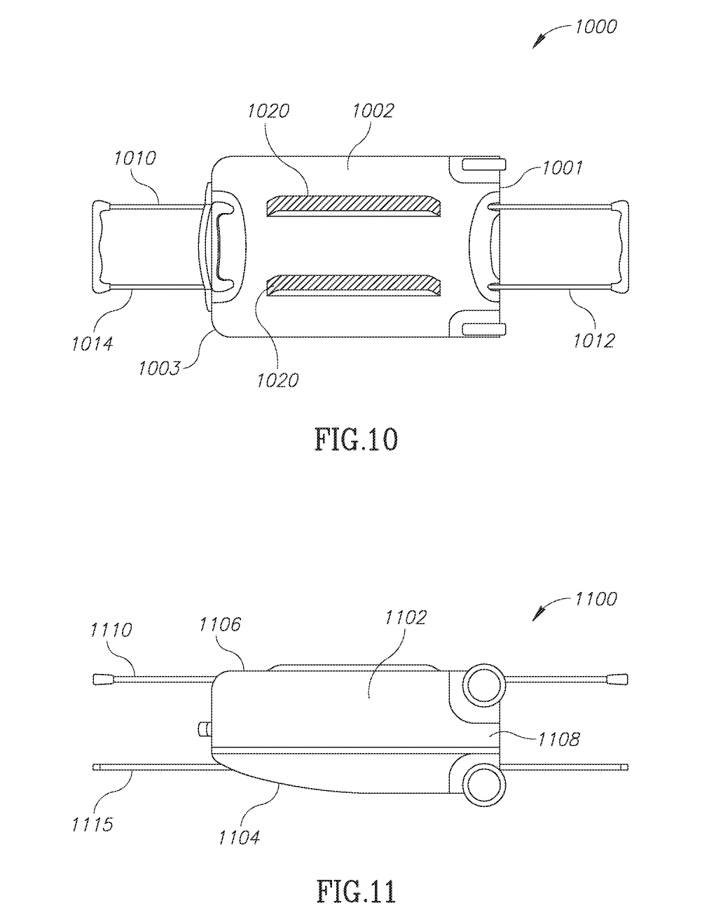

Reference is now made to FIG. 10, which depicts a rear side view of a luggage carrier 1000 including adhesive members 1020, according to some embodiments. The body 1002 of luggage carrier 1000 is made from a stiff, lightweight material enabling safe use in all weather conditions and is aerodynamic in shape, so as to cause minimal drag when mounted on a vehicle. Luggage carrier 1000 is here shown to include two adhesive members, however it is understood that a different number of adhesive members is also contemplated and thus within the scope of this disclosure, Similarly, adhesive members are here shown as being parallel positioned on the rear side of luggage carrier 1000, however it is understood that other configurations, are also feasible and thus within the scope of this disclosure. Adhesive members 1020 may also serve as shock absorbing cushions configured to absorb impact between luggage carrier 1000 and the external surface to which it is mounted (not shown). Luggage carrier 1000 also includes an extendable rod 1010 extending from a rear side of luggage carrier 1000, in such manner that a first end 1012 of extendable rod 1010 protrudes from bottom end 1001 of luggage carrier 1000 and a second end 1014 of extendable rod 1010 protrudes from top end 1003 of luggage carrier 1000.

Reference is now made to FIG. 11, which depicts a side view of a luggage carrier 1100 including extendible rods 1110 and 1115 extending from a front 1104 and a rear 1106 side of luggage carrier 1100, thereby enabling attachment of luggage carrier 1100 to an external surface of a vehicle (not shown) along a side 1108 thereof.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” or “comprising”, when used in this specification, specify the presence of stated features, integers, steps, operations, elements, or components, but do not preclude or rule out the presence or addition of one or more other features, integers, steps, operations, elements, components, or groups thereof. Unless otherwise defined, all technical and scientific terms used herein have the same meaning as commonly understood by one of ordinary skill in the art to which this invention belongs.

While a number of exemplary aspects and embodiments have been discussed above, those of skill in the art will recognize certain modifications, additions and sub-combinations thereof. It is therefore intended that the following appended claims and claims hereafter introduced be interpreted to include all such modifications, additions and sub-combinations as are within their true spirit and scope.

1. A luggage carrier comprising a mounting element configured to attach the luggage carrier to an external surface of a vehicle.

2. (canceled)

3. The luggage carrier of claim 1, further comprising a release mechanism configured to prevent release of said mounting element from the external surface of the vehicle unless the release mechanism is actively triggered.

4.-5. (canceled)

6. The luggage carrier of claim 1, further comprising a GPS configured to enable tracking thereof.

7. (canceled)

8. The luggage carrier of claim 1, wherein the mounting element comprises an extendable rod, a magnet, an electromagnet, a vacuum member, a biological glue, a nonskid adhesive material, a hook and loop fastener or any combination thereof.

9. The luggage carrier of claim 1, wherein the mounting element comprises an extendable rod comprising at least two handles, the handles comprising a mounting mechanism enabling mounting of the luggage carrier to an external surface of a vehicle; wherein said extendable rod is configured to assume at least a first essentially non-extended position and a second at least partially extended position.

10. The luggage carrier of claim 9, wherein said at least two handles are configured to assume a position essentially perpendicular to the at least one extendable rod when mounted to the external surface of the vehicle, such that a gap is formed between the external surface of the vehicle and the at least one extendible rod.

11. The luggage carrier of claim 10, wherein the at least one rod is a double-armed extendable rod comprising two handles, each handle at opposite ends of said extendible rod.

12. The luggage carrier of claim 11, wherein said single extendable rod is a telescopic rod configured to be extended at both ends thereof.

13. The luggage carrier of claim 9, wherein the at least one extendable rod is positioned on the luggage carrier such that a first of the at least two handles is at a bottom side of the luggage carrier and the second of the at least two handles is at the top side of the luggage carrier.

14. (canceled)

15. The luggage carrier of claim 10, further comprising a switch mechanism configured for switching between said first essentially non-extended position and said second at least partially extended position.

16. The luggage carrier of claim 1, wherein the mounting element is an integral part of the luggage carrier.

17.-18. (canceled)

19. A mounting device configured for attachment to a luggage carrier, the mounting device comprising at least one extendable rod configured for attachment to the luggage carrier, the at least one extendable rod comprising at least two handles, the handles comprising a mounting mechanism enabling mounting of the extendable rod to an external surface of a vehicle; wherein said extendable rod is configured to assume at least a first essentially non-extended position and a second at least partially extended position; and wherein said extendable rod is configured for attachment to said luggage carrier when in its first essentially non-extended position prior to the mounting of the extendable rod to the external surface of the vehicle.

20. The device of claim 19; wherein at least one of the at least two handles is configured to assume a first position in which the handle is coextensive with the extendable rod and a second position in which the handle assumes a position essentially perpendicular to the extendable rod.

21. The device of claim 19, wherein said at least two handles are configured to assume a position essentially perpendicular to the at least one extendable rod when mounted to the external surface of the vehicle such that a gap is formed between the external surface of the vehicle and the at least one extendible rod.

22. The device of claim 19, wherein the at least one rod is a double-armed extendable rod comprising two handles, each handle at opposite ends of said double armed extendible rod.

23. The device of claim 22, wherein said double-armed extendable rod is a telescopic rod configured to be extended at both ends thereof.

24.-26. (canceled)

27. The device of claim 19, wherein the mounting mechanism is selected from mechanical, magnetic, electromagnetic, adhesive, hook and loop fastener or any combination thereof.

28. The device of claim 19, wherein the mounting mechanism comprises a release mechanism configured to prevent release of said extendable rod from the external surface of the vehicle unless the release mechanism is actively triggered.

29. The device of claim 19, further comprising a switch mechanism configured for switching between said first essentially non-extended position and said second at least partially extended position.

30. The device of claim 19, further comprising a detachment mechanism allowing detachment of said luggage carrier from said extendable rod only when said detachment mechanism is activated.

31.-32. (canceled)
